(19) United States
(12) Patent Application Publication
(10) Pub. No.: US 2016/0344839 A1
(43) Pub. Date: Nov. 24, 2016

(54) MESSAGE SYNCHRONIZATION ACROSS MULTIPLE CLIENTS

(71) Applicant: International Business Machines Corporation, Armonk, NY (US)

(72) Inventors: Brendan P. Arthurs, Dublin (IE); Uriel Segev, Savyon (IL)

(21) Appl. No.: 15/180,106

(22) Filed: Jun. 13, 2016

Related U.S. Application Data
(63) Continuation of application No. 14/717,306, filed on May 20, 2015.

(51) Int. Cl. H04L 29/08; H04L 12/18

(52) U.S. Cl. CPC H04L 67/32; H04L 67/10; H04L 67/147; H04L 12/1859; H04L 12/18

(57) ABSTRACT

Methods for message synchronization are described herein. The methods include establishing, via a message server, a communication channel session between a first client of a first user and a second client among a plurality of clients of a second user. The second client is designated as a primary client among the plurality of clients of a second user during the session, and a message to be exchanged between the first client and the second client via the message server is enabled. The methods may also include providing, from the message server, message history associated with the session to a message history data store comprising a computing device that is discrete from the message server. The message history may be provided to a third client among the plurality of clients of the second user via the message history data store, rather than the message server.

### BACKGROUND OF THE INVENTION

The present invention relates generally to messaging, and in particular, to message synchronization. In telecommunication, messaging systems may broadcast messages to all client devices associated with a user. Other systems may only send a message to one predetermined client device associated with a user.

In some cases, client capabilities may vary. For example, a desktop client may enable messaging features and capabilities such as rich text, sending and receiving of images, sending and receiving of files, and the like. As another example a web client may support rich text and the receiving and sending of images, but may not support the sending and receiving of screen shots. As yet another example, a mobile client may only support plain text. In such systems wherein multiple clients having different messaging capabilities are associated with a given user, a message server may be forced to reduce capabilities of a messaging session to the features associated a lowest feature enabled client.

### SUMMARY

In one embodiment, computer implemented method for message synchronization is described herein. The method may include establishing, via a message server, a communication channel session between a first client of a first user and a second client among multiple clients of a second user, and designating the second client as a primary client among the clients of a second user during the session. A message to be exchanged between the first client and the second client may be enabled via the message server. Message history associated with the session may be provided from the message server to a message history data store comprising a computing device that is discrete from the message server. The message history may be provided to a third client among the clients of the second user via the message history data store, rather than the message server.

In another embodiment, a system for message synchronization is described herein. The system includes a message server and a message history data store comprising a computing device discrete from the message server. The message server may be configured to establish a communication channel session between a first client of a first user and a second client among a plurality of clients of a second user, and designate the second client as a primary client among the plurality of clients of a second user during the session. The message server may also be configured to enable a message to be exchanged between the first client and the second client via the message server. The message history data store may be configured to receive, from the message server, message history associated with the session, and provide the message history to a third client among the plurality of clients of the second user via the message history data store rather than the message server.

In yet another embodiment, computer program product for message synchronization is described herein. The computer product includes a computer readable storage medium having program code embodied therewith, the program code executable by a processor to perform a method including establishing, via a message server, a communication channel session between a first client of a first user and a second client among multiple clients of a second user, and designating the second client as a primary client among the clients of a second user during the session. A message to be exchanged between the first client and the second client may be enabled via the message server. Message history associated with the session may be provided from the message server to a message history data store comprising a computing device that is discrete from the message server. The message history may be provided to a third client among the clients of the second user via the message history data store, rather than the message server.

### BRIEF DESCRIPTION OF THE DRAWINGS

FIG. 1 is a block diagram of a messaging system wherein multiple clients are communicatively coupled to components of the messaging system;

FIG. 2 is a block diagram of a messaging system wherein a primary client is redesignated from among multiple clients communicatively coupled to components of the messaging system;

FIG. 3 is a flow diagram illustrating providing message history to multiple clients;

FIG. 4 a flow diagram illustrating providing message history to multiple clients based on restrictions of a communication channel; and

FIG. 5 is a block diagram depicting an example of a tangible, non-transitory computer-readable medium that can be used for message synchronization.

### DETAILED DESCRIPTION

The subject matter disclosed herein relates to methods for message synchronization. As discussed above, messaging systems may function to broadcast a message from a message server to all client devices associated with a given client. However, in channel-based messaging, a predetermined channel is used to forward a message to a predetermined client, rather than all client devices associated with a given user. The methods described herein relate to a channel-based messaging system wherein messaging is enabled during a session between two or more users via a message server. The messaging is enabled by the messaging server based on predetermined channels associated with each client device of a given user. A message history data store may receive message history from the message server and provide the message history to other clients not currently connected to the message sever during the session.

A channel-based messaging system, as referred to herein, is a messaging system wherein a channel or path is predefined for communication with a given client. The predefined channel may enable only one client device to establish a session with a message server at a given time. In a channel-based messaging, a user having multiple client devices may encounter issues when the user switches client devices as only one of the client devices was receiving messages from the message server at a time. The techniques described herein include a message history data store that is separate and discrete from the message server that may gather message history and provide the message history to other client devices of the user that are currently not in session with the message server.

Therefore, in comparison to broadcast-type messaging system which may provide a message to all clients associated with a user from a message server, the techniques described herein include a separate discrete message history data store that is discrete from the message server. Rather than broadcast messages from the message server to all client devices associated with a given user, the techniques described herein include enabling messages to be received at a primary client device associated with a user and providing message history to other secondary client devices associated with the given user from the discrete message history data store. The message history may be provided in response to polling the message history data store by one or more of the secondary client devices, or by a subscription-based scheme wherein message history is pushed to the secondary client devices. When a user switches client devices, message history may already appear at a newly selected client device, and the newly selected client device may be designated as a new primary device, and establish channel-based communication with the message server.

Further, in some cases, client devices of a given user may have various feature capabilities that are different from client devices of another user. In this scenario, the techniques described herein include restricting a communication channel based on capabilities of one of the client devices being less than capabilities of a client device of another user.

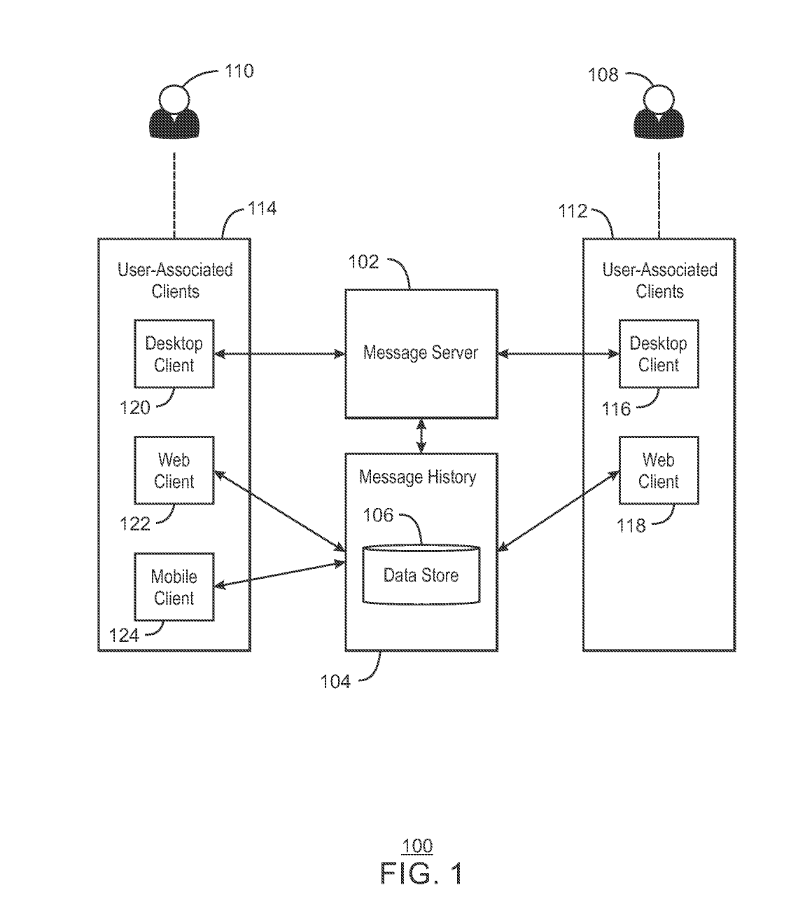

FIG. 1 is a block diagram of a messaging system wherein multiple clients are communicatively coupled to components of the messaging system. The messaging system 100 may include a message server 102 and a message history device 104 having a data store 106. The data store 106 may be referred to herein as the message history data store 106. The message server 102 and the message history device 104 may be computing devices. However, the message server 102 may be discrete from the message history device 104.

For example, the message server 102 may be located at a different location than the message history device 104. Further, as the requirements of the message history device 104 may be quite different from the requirements of the message server 102, each may be comprised of different component configurations. For example, the message history data store 106 of the message history device 104 may include a persistent long-term storage in comparison to short-term storage of the message server 102. As another example, the message server 102 may be configured to include computing components having relatively low latency for providing messages to client devices, while the message history device 104 may be configured to include components having relatively higher latency. In other words, the messaging server 102 and the message history device 104 may be configured to have different levels of computing features based on different configurations of computing components such as memory, storage, processing devices, and the like.

As illustrated in FIG. 1, a first user 108 and a second user 110 may be configured to exchange messages via the message server 102. Each user 108 and 110 may be associated with multiple client devices, as indicated at 112 and 114. For example, the first user 108 may be associated with a desktop client 116 and a web client 118. The second user 110 may be associated with a desktop client 120 and a web client 122 as well as a mobile client 122. Other client devices are contemplated although not illustrated in FIG. 1.

During channel-based communication, a session may be established between the message server 106, the desktop client 116 of the first user 108 and the desktop client 120 of the second user 110. The channel-based communication may establish a communication channel based on a predefined communication channel for communicating with any of the client devices of a given user. For example, the message server 106 may establish a session via a predefined communication channel that is used for all of the client devices of the second user 110 including the desktop client 120, the web client 122, and the mobile client 124. In some cases, the predefined communication channel may be different for each type of client device including the desktop client 120, the web client 122, the mobile client 124, and the like. In either case, the communication channel may be predefined before initiating the session with the message server 102.

The message server 102 may be configured to establish a communication channel session between a first client, such as the desktop client 116 of the first user 108, and a second client, such as the desktop client 120, among a plurality of clients, such as including the web client 122 and the mobile client 124, of the second user 110. The message server 102 may be configured to designate the desktop client 120 as a primary client among the plurality of clients 120, 122, 124 of the second user during the session. In this scenario, the other clients including the web client 122 and the mobile client 124 are designated as secondary clients. The message server 102 may be configured to enable a message to be exchanged between the desktop client 116 and the desktop client 118.

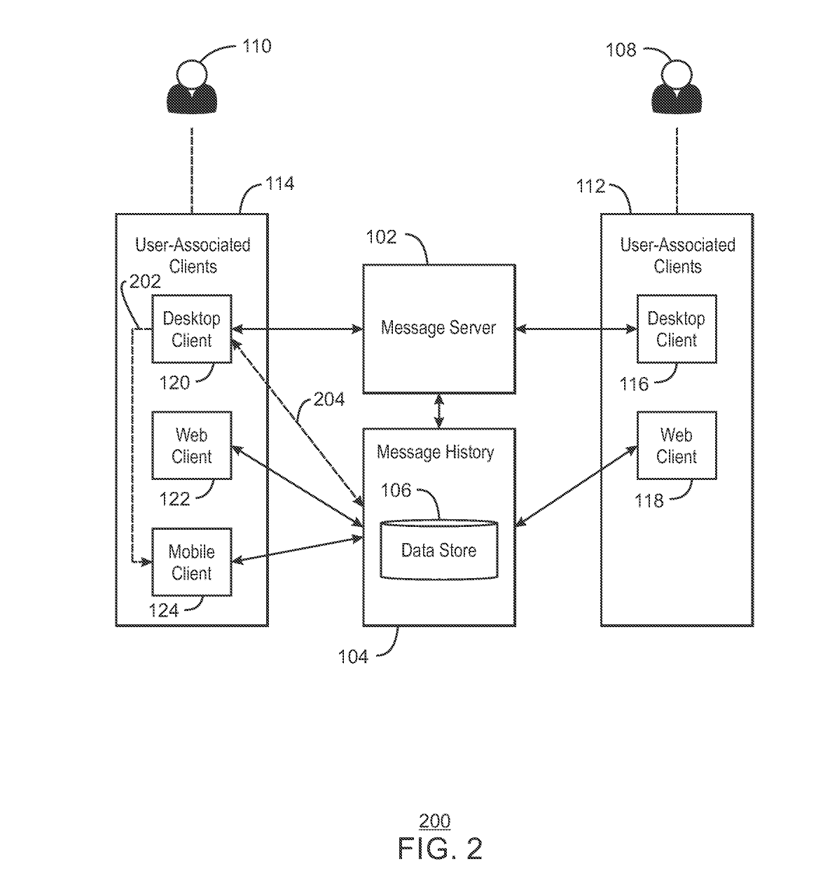

The message history device 104 including the message history data store 106 may be configured to receive, from the message server 102, message history associated with the session. The message history device 104 including the message history data store 106 may be configured to provide the message history to a third client, such as the web client 122, the mobile client 124, or any combination thereof, of the second user rather than via the message server 102. In some cases, message history may be provided from the message history data store 106 as a result of polling by one or more of the secondary clients including the web client 122 and the mobile client 124. In other cases, the message history may be provided by pushing the message history to the secondary client devices, such as the client devices 122 and 124 in FIG. 1. Further, in some cases, the message history may be provided by any combination of polling and pushing to the secondary client devices 122 and 124. As discussed in more detail below in regard to FIG. 2, designation of a primary client and secondary client(s) may change based on which client device is currently being used by a user, such as the user 110.

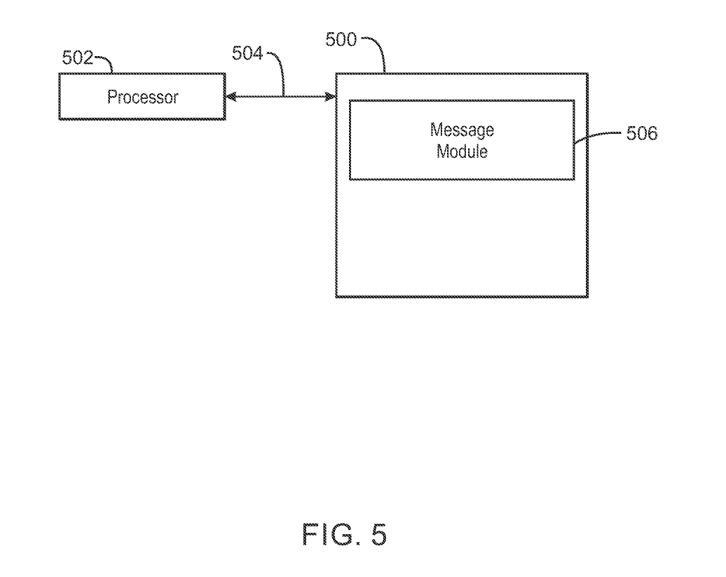

As discussed above and in more detail below in regard to FIG. 5, the message server 102 may be further configured to determine communication capabilities of the first client 108, and determine communication capabilities of the second client 110. The message server 102 may restrict the communication channel based on capabilities of the first client 108 being less than the capabilities of the second client 110. Alternatively, the message server may restrict the communication channel based on capabilities of the second client 110 being less than the capabilities of the first client 108. In either scenario, the communication channel may be configured based on the messaging capabilities and features of clients that are in session with the message server 102, such as the desktop client 116 and the desktop client 120 of FIG. 1.

FIG. 2 is a block diagram of a messaging system wherein a primary client is redesignated from among multiple clients communicatively coupled to components of the messaging system. In some cases, a user, such as the second user 110 of FIG. 1 may switch from one client device to another client device. For example, the second user 110 may initially establish a session with the message server 102 using the desktop client 120, as illustrated in FIG. 1. However, in FIG. 2, the second user 110 switches to using the mobile client 124, as indicated by the dashed double-arrow line 202.

A predefined communication channel is established with the mobile client 124. Before a session is established via the predefined communication channel with the mobile client 124 and the message server 102, message history has been provided to the mobile client 124 as indicated by the dashed line 204. Therefore, the second user 110 may switch client devices without interruption and with message history context.

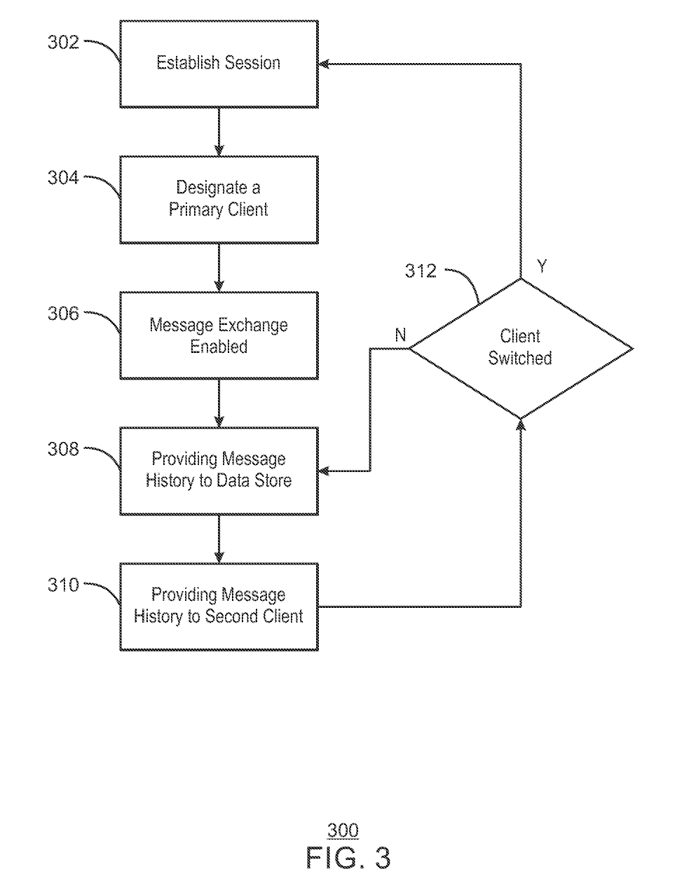

In FIG. 2, the mobile client 124 is designated as the primary client, while the desktop client 120 and the web client 122 are designated as secondary clients. The client devices 120 and 122 receive message history from the message history data store 106. As discussed in more detail below in regard to FIG. 3, each time a user, such as the user 110 of FIG. 2, switches client devices, a new session is started designating the newly selected client device as the primary client device while other associated client devices are designated as secondary client devices to receive message history from the message history data store 106.

FIG. 3 is a flow diagram illustrating providing message history to multiple clients. In a messaging process 300, at 302, a session is established. As discussed above, a session may be established to communicatively couple two client devices of different users via a message server. The communicative coupling may include establishing a communication channel. The communication channel may be predetermined.

A session may be established for only one client device of a given user at a time. However, a user may have multiple client devices. Therefore, at block 304, a primary client is designated. The primary client is designated as the client which is currently in session with the message server. At block 306, message exchange is enabled. At block 308, message history may be provided to a message history data store, such as the message history data store 106 of FIG. 1. The message history may be provided, at block 310, to one or more secondary clients.

At 312, a determination is made as to whether the client device has been switched. In other words, a determination is made as to whether messaging has been enabled by another client device other than the previously designated primary device. If another client device has been selected, then the process 300 begins again at 302. If another client device has not been selected, then the process 300 reverts to 308 wherein message history data is provided to the message history data store.

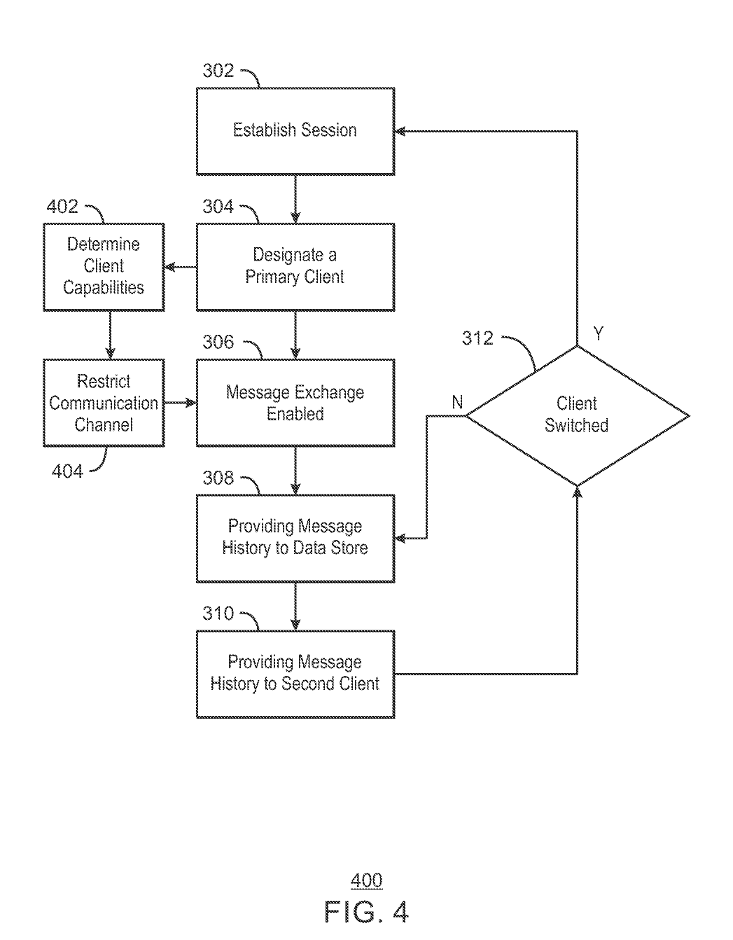

FIG. 4 a flow diagram illustrating providing message history to multiple clients based on restrictions of a communication channel. As discussed above in regard to FIG. 1, in some cases, client devices may have different levels of messaging capabilities. In this scenario, a messaging process 400 may include the elements of FIG. 3. After a primary client has been designated at 304, client capabilities may be determined at 402. At block 404, the communication channel may be restricted based on the capabilities determined at block 404. In some cases the communication channel may be restricted by disabling certain messaging capabilities of a client that is in session based on another client in session with lower capabilities.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer system readable media may be utilized. Computer system readable media may be in the form of volatile memory, such as random access memory (RAM), read-only memory (ROM), erasable programmable read-only memory (EPROM or flash memory), and/or cache memory. A computer system/server or message module may further include other removable/non-removable, volatile/non-volatile computer system storage media. By way of example only, a storage system can be provided for reading from and writing to a non-removable, non-volatile magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive may connect to a computer system, processor, and/or message module via a bus. The bus may use one or more data media interfaces. Memory may include at least one program product having a set (e.g., at least one) of program modules that are configured to carry out the functions of embodiments of the invention.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 5 is a block diagram depicting an example of a tangible, non-transitory computer-readable medium that can be used for message synchronization. The tangible, non-transitory, computer-readable medium 500 may be accessed by a processor 502 over a computer bus 504. Furthermore, the tangible, non-transitory, computer-readable medium 500 may include computer-executable instructions to direct the processor 502 to perform the steps of the current method.

The various software components discussed herein may be stored on the tangible, non-transitory, computer-readable medium 500, as indicated in FIG. 5. For example, a message module 506 may be configured to establish, via a message server, a communication channel session between a first client of a first user and a second client among a plurality of clients of a second user. The message module 506 may also be configured to designate the second client as a primary client among the plurality of clients of the second user during the session, and enable a message to be exchanged between the first client and the second client.

The message module 506 may also be configured to enable a message history data store to receive, from the message server, message history associated with the session. The message module 506 may further be configured to provide the message history to a third client among the plurality of clients of the second user via the message history data store rather than the message server.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for message synchronization, comprising:
establishing, via a message server, a communication channel session between a first client of a first user and a second client among a plurality of clients of a second user;
designating the second client as a primary client among the plurality of clients of the second user during the session;
enabling a message to be exchanged between the first client and the second client via the message server;
providing message history associated with the session to a message history data store comprising a computing device that is discrete from the message server; and
providing the message history to a third client among the plurality of clients of the second user via the message history data store, rather than the message server.

2. The computer implemented method of claim 1, wherein the communication channel is predetermined before establishing the communication channel session.

3. The computer implemented method of claim 1, further comprising:
determining communication capabilities of the first client;
determining communication capabilities of the second client; and
restricting the communication channel based on capabilities of the first client being less than the capabilities of the second client.

4. The computer implemented method of claim 1, wherein the communication channel session is a first communication channel session, further comprising:
establishing a second communication channel session between the first and the third client;
terminating the second client as the primary client; and
designating the third client as the primary client among the plurality of clients of the second user.

5. The computer implemented method of claim 1, wherein providing the message history to the third client via the message history data store comprises:
polling the message history data store for the message history; and
receiving the message history in response to the polling of the third client.

6. The computer implemented method of claim 1, wherein the communication channel session is a first communication channel session, and wherein providing the message history to the third client via the message history data store comprises pushing, via the message history data store, the message history to the third client via a second communication channel that is distinct from the first communication channel.

7. The computer implemented method of claim 1, wherein designating the second client as the primary client comprises restricting any other clients of the plurality of clients of the second user to access the message server during the communication channel session, except via the message history data store.
